(19) United States
(12) Patent Application Publication
(10) Pub. No.: US 2024/0086607 A1
(43) Pub. Date: Mar. 14, 2024

(54) MODELING OF A DESIGN IN RETICLE ENHANCEMENT TECHNOLOGY

(71) Applicant: D2S, Inc., San Jose, CA (US)

(72) Inventors: P. Jeffrey Ungar, Belmont, CA (US); Akira Fujimura, Saratoga, CA (US); Ajay Baranwal, Dublin, CA (US); Suhas Pillai, San Jose, CA (US)

(73) Assignee: D2S, Inc., San Jose, CA (US)

(21) Appl. No.: 18/515,140

(22) Filed: Nov. 20, 2023

Related U.S. Application Data
(63) Continuation-in-part of application No. 18/175,313, filed on Feb. 27, 2023.
Application No. 18/175,313 is a continuation of application No. 17/652,881, filed on Feb. 28, 2022, now Pat. No. 11,620,425.
Application No. 17/652,881 is a division of application No. 17/248,325, filed on Jan. 20, 2021, now Pat. No. 11,301,610.
Application No. 17/248,325 is a continuation-in-part of application No. 15/930,774, filed on May 13, 2020, now Pat. No. 10,909,294.
Application No. 15/930,774 is a continuation of application No. 15/853,311, filed on Dec. 22, 2017, now Pat. No. 10,657,213.

(51) Int. Cl. G06F 30/39; G03F 1/36; G03F 1/44; G03F 7/00

(52) U.S. Cl. CPC G06F 30/39; G03F 1/36; G03F 1/44; G03F 7/705; G06F 2119/18

(57) ABSTRACT

Methods and systems for reticle enhancement technology (RET) include inputting a target wafer pattern, where the target wafer pattern spans an entire design area. The entire design area is divided into a plurality of tiles, each tile having a halo region surrounding the tile. An optimized mask is calculated, wherein the optimized mask is generated by a first trained neural network using the target wafer patter. The calculating is performed for each tile in the plurality of tiles including its halo region.

### RELATED APPLICATIONS

This application is a continuation-in-part of U.S. patent application Ser. No. 18/175,313, filed on Feb. 27, 2023, and entitled “Methods for Modeling of a Design in Reticle Enhancement Technology”; which is a continuation of U.S. patent application Ser. No. 17/652,881, filed on Feb. 28, 2022, issued as U.S. Pat. No. 11,620,425, and entitled “Methods for Modeling of a Design in Reticle Enhancement Technology”; which is a divisional of U.S. patent application Ser. No. 17/248,325, filed on Jan. 20, 2021, issued as U.S. Pat. No. 11,301,610 and entitled “Methods for Modeling of a Design in Reticle Enhancement Technology”; which is a continuation-in-part of U.S. patent application Ser. No. 15/930,774, filed on May 13, 2020, issued as U.S. Pat. No. 10,909,294 and entitled “Modeling of a Design in Reticle Enhancement Technology; which is a continuation of U.S. patent application Ser. No. 15/853,311, filed on Dec. 22, 2017, issued as U.S. Pat. No. 10,657,213 and entitled “Modeling of a Design in Reticle Enhancement Technology”; all of which are hereby incorporated by reference in their entirety.

### BACKGROUND

Submicron manufacturing uses lithographic techniques to build up layers of materials on a substrate to create transistors, diodes, light-emitting diodes (LEDS), capacitors, resistors, inductors, sensors, wires, optical wires, microelectromechanical systems (MEMS) and other elements which collectively produce a device that serves some function. Substrate lithography is a printing process in which a mask, sometimes called a reticle, is used to transfer patterns to a substrate to create the device. In the production or manufacturing of a device, such as an integrated circuit or a flat panel display, substrate lithography may be used to fabricate the device. When the device to be created is an integrated circuit, typically the substrate is a silicon wafer. In creating an integrated circuit, the lithography is semiconductor lithography which for high volume production is typically a substrate lithography. Other substrates could include flat panel displays, liquid panel display, a mask for flat panel display, nanoimprint masters, or other substrates, even other masks.

In semiconductor lithography, the mask or multiple masks may contain a circuit pattern corresponding to an individual layer, or a part of a layer in multiple patterning processes, of the integrated circuit. This pattern can be imaged onto a certain area on the substrate that has been coated with a layer of radiation-sensitive material known as photoresist or resist. Once the patterned layer is transferred the layer may undergo various other processes such as etching, ion-implantation (doping), metallization, oxidation, and polishing. These processes are employed to finish an individual layer in the substrate. If several layers are required, then the whole process or variations thereof will be repeated for each new layer. Eventually, a combination of multiples of devices, which may be integrated circuits, will be present on the substrate. These devices may then be separated from one another by dicing or sawing and then may be mounted into individual packages.

Optical lithography may be 193 nm light, with or without immersion, or extreme ultraviolet (EUV) or X-ray lithography, or any other frequencies of light or any combination thereof.

Optical lithography that uses 193 nm light waves works with refractive optics and transmissive photomasks or reticles. The masks block, partially block, or transmit the light waves selectively on to a substrate, which is typically resist-coated during the lithographic process, to partially expose or to expose different parts of the substrate or some material on the substrate. The masks are typically at 4× magnification of the target substrate dimensions.

Extreme Ultraviolet Lithography (EUV) uses approximately 13.5 nm wavelength of light with reflective optics. Some implementations use an anamorphic mask with magnifications of 8× in one dimension and 4× in the other dimension.

In general, smaller wavelengths of light are able to resolve finer geometries, finer spaces in between geometries, and a higher frequency (density) of features on the substrate. Also in general, smaller wavelengths of light are more difficult to reliably produce and control. Economically, it is best to use the largest wavelength of light that is able to resolve the feature sizes, spaces, and frequencies that are needed for the device. It is therefore of interest to enhance the resolution achievable on the substrate with any given wavelength(s) of light.

For any lithography of a particular resolution, additional techniques such as off-axis illumination, phase shift masks, and multiple patterning extend the resolution capabilities. When multiple patterning is used, a single substrate layer is exposed multiple times, each time using a different mask which is called a mask layer.

Masks are created by electron beam (eBeam) machines, which shoot electrons at a photo resist coating a surface, which is then processed to produce the desired openings in the mask. The amount of energy delivered to a spot on the mask is called the dose, which may have no energy at a dose set to 0.0 and a nominal dose set to 1.0 by convention. A pattern will be registered when the dose exceeds a certain threshold, which is often near 0.5 by convention. Critical dimension (CD) variation is, among other things, inversely related to the slope of the dosage curve at the resist threshold, which is called edge slope or dose margin.

There are a number of technologies used by eBeam machines. Three common types of charged particle beam lithography are variable shaped beam (VSB), character projection (CP), and multi-beam projection (MBP). The most commonly-used system for leading edge mask production is VSB. VSB and CP are sub-categories of shaped beam charged particle beam lithography, in which an electron beam is shaped by a series of apertures and steered to expose a resist-coated surface. MBP uses plurality of charged particle beams whereas VSB and CP machines typically have a single beam.

It is difficult to print features whose size is similar to or smaller than the wavelength of the light used for lithography. The industry has applied various techniques to address the difficulty of reliably printing a desired shape on the substrate. A computational lithography field has emerged to use computing to enhance the substrate lithography, which in semiconductor lithography is also referred to as wafer lithography. Reticle Enhancement Technologies (RET) include computational methods and systems to design the target reticle shapes with which to project the desired pattern on the substrate more precisely and more reliably across manufacturing variation. RET often use computation to enhance an image on a mask, to print a desired substrate pattern more accurately and more reliably with resilience to manufacturing variation. The two common techniques in RET are Optical Proximity Correction (OPC) and Inverse Lithography Technology (ILT). OPC and ILT are often iterative optimization algorithms that adjust parameters defining the mask until the predicted pattern on wafer is within acceptable tolerances for a set or a range of conditions. OPC manipulates mask geometries and simulates the wafer pattern near target edges. ILT manipulates the mask transmission as pixels, and ILT typically simulates the entire wafer pattern, a process known as dense simulation. An iterative optimization algorithm typically consists of: (1) evaluate a proposed solution to assign a cost which is trying to be minimized; (2) if cost is below a cost criteria, stop; (3) calculate a gradient for each element of the proposed solution which would lead to a lower cost; (4) adjust the proposed solution according to the calculated gradients; (5) go back to (1). Costs are typically defined with positive values where zero is the best possible score as assumed here. However, alternative cost definitions may be used.

RET in general means to improve the printability of all desired features at nominal (expected) manufacturing conditions and within expected manufacturing variation around the nominal manufacturing conditions. Since manufacturing processes are not perfect, the design needs to be resilient to certain expected manufacturing variation. A larger process window means more resiliency to manufacturing variation, specifically that pattern discrepancies through defocus and dose variation are within an acceptable tolerance. Providing sufficient process window for as many of the features as possible is a goal of RET. The percentage of chips that function as specified after fabrication is often referred to as the yield. Many factors affect yield. Improving the process window is generally considered among those skilled in the art to correlate to improving yield.

### SUMMARY

In some embodiments, a method for reticle enhancement technology (RET) includes inputting a target wafer pattern, the target wafer pattern spanning an entire design area; dividing the entire design area into a plurality of tiles, each tile having a halo region surrounding the tile; and calculating an optimized mask, wherein the optimized mask is generated by a first trained neural network using the target wafer pattern. The calculating is performed for each tile in the plurality of tiles including its halo region.

In some embodiments, a system for reticle enhancement technology (RET) includes a computer cluster configured to receive a target wafer pattern, the target wafer pattern spanning an entire design area; and calculate an optimized mask, wherein the optimized proposed mask is generated by a trained neural network using the target wafer pattern.

### BRIEF DESCRIPTION OF THE DRAWINGS

FIG. 1 is a block diagram of a chip design being processed into a wafer, as known in the art.

FIG. 2 is an embodiment of methods related to calculating a Continuous Tone Mask (CTM) according to the present disclosure, then converting the CTM to a Quantized Tone Mask (QTM).

FIG. 3A is another embodiment of methods according to the present disclosure.

FIG. 3B provides example illustrations of the steps corresponding to the flowchart of FIG. 3A.

FIG. 4 illustrates a target pattern, with a corresponding continuous tone mask (CTM) and a quantized tone mask (QTM), according to embodiments of the present disclosure.

FIG. 5 is an embodiment of distributed computation for reticle enhancement technology according to the present disclosure, in which the entire design iterates over an optimization loop for some time.

FIGS. 6A-6C illustrate training a neural network for RET, an embodiment of methods according to the present disclosure.

FIG. 7 is a diagram illustrating a neural network architecture for generating either a CTM or a QTM, an embodiment of methods according to the present disclosure.

FIG. 8 is a flow illustrating the use of neural networks for RET, an embodiment of methods according to the present disclosure.

FIG. 9 is a block diagram of an embodiment of a computing hardware system that may be used in embodiments of the present disclosure.

FIG. 10 is a block diagram of another embodiment of a computing hardware system, a Computational Design Platform (CDP), that may be used in embodiments of the present disclosure.

### DETAILED DESCRIPTION OF THE EMBODIMENTS

In this disclosure, use of the term wafer lithography shall refer to substrate lithography in general. That is, embodiments shall be described in terms of semiconductor lithography as an example to simplify comprehension, but the embodiments apply also to other types of substrate lithography and to overall reticle enhancement technology. The term “substrate” in this disclosure can refer to a mask used in lithography, a silicon wafer, flat panel displays, a liquid panel display, a mask for flat panel display, nanoimprint masters, or other substrates, or other masks.

Conventional Techniques

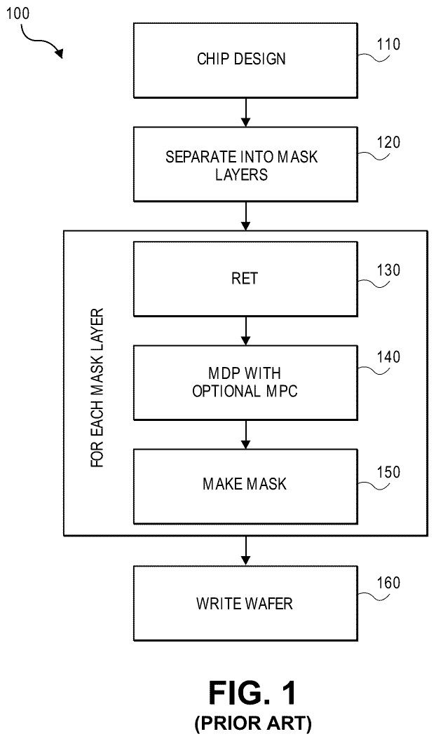

Traditional semiconductor manufacturing flow 100 is depicted in FIG. 1. Chip design is accomplished by creating a composite of wafer layers in step 110. In step 120, some of the wafer layers are separated into mask layers. This step also includes what is sometimes referred to as the coloring step, where each feature on a wafer layer is colored to reflect the assignment of a feature to a particular mask layer. Once the mask layers are separately identified, each mask layer goes through the RET step 130. Mask data preparation (MDP) step 140 then prepares the data for a mask writer. This step may include “fracturing” the data into trapezoids, rectangles, or triangles. Mask Process Correction (MPC) geometrically modifies the shapes and/or assigns dose to the shapes to make the resulting shapes on the mask closer to the desired shape. MPC is sometimes performed in step 130, sometimes in step 140, sometimes in step 150, and sometimes in any combination. Pixel dose modification as is disclosed in U.S. Pat. No. 10,444,629, “Bias Correction for Lithography,” which is owned by the assignee of the present application may also be applied in step 150. A mask is made and verified in step 150, which includes such steps as mask writing, mask inspection, metrology, mask defect disposition, mask repair, and wafer-plane inspection of the mask. In step 160, the wafer is written using a successive collection of the masks made in step 150.

In each of the steps in FIG. 1, there may or may not be a verification step to thoroughly verify or sanity check the output of that step. In the art, some of the steps of FIG. 1 are performed in a different sequence or in parallel. An example of a pipelined processing in a semiconductor manufacturing process is when a design is divided into multiple tiles, for example an array of equal-sized tiles, and then a first step is performed for a tile, and then a second step is performed for that tile without waiting for the other tiles to finish the first step. For example, RET step 130 and MDP step 140 may be pipelined to reduce the turnaround time. In another example, the MPC of step 140 may be pipelined with the mask making of step 150.

In wafer lithography, features that are needed on the substrate, referred to as main features, are found to print with greater fidelity and improved process window if extra features are added to the mask that are too small to print themselves, but nevertheless favorably affect the way nearby main features print. These extra features are called sub-resolution assist features (SRAFs). They are isolated shapes, unattached to a main feature, which are small enough not to print on the substrate.

Computing SRAFs and main feature modifications is highly compute-intensive with fragile results. Spurious extra patterns may print, the target pattern may not be fitted well, and the process window may be needlessly limited. A typical RET method has OPC verification to identify and correct hot spots. A hot spot is an area requiring ideal conditions to print properly and therefore is not resilient to manufacturing variation, or in some cases would not print properly even in ideal conditions. Hot spots lead to poor yield.

ILT often generates unexpected—i.e., non-intuitive—mask patterns which provide excellent results. ILT algorithms naturally create curvilinear shapes including many SRAFs. Curvilinear shapes have proven to be impractical for variable shaped beam (VSB) mask writing machines with conventional fracturing because very many VSB shots are required to expose the curvilinear shapes. Mask write times are a critical business factor, and VSB writing time scales with the number of VSB shots that need to be printed. When converting the mask patterns generated by inverse lithography technology (ILT) algorithms to VSB, considerable runtime is spent to convert the curvilinear shapes into an approximation that is more suitable for VSB writing, a process often referred to as Manhattanization. Model-based mask data preparation using overlapping shots can significantly reduce the write time impact. But still, curvilinear shapes take longer to write than Manhattan shapes. The recently introduced multi-beam electron beam mask writing systems write curvilinear shapes directly on a mask without taking any additional time. This enables ILT to output curvilinear shapes without the need for Manhattanization. Another significant problem with ILT is the huge computational demands of dense simulations of full mask layers of full designs, particularly full-reticle sized designs, which for semiconductor manufacturing is typically around 3.0 cm×2.5 cm in wafer dimensions.

Multi-beam writing eliminates the need to Manhattanize curvilinear shapes for VSB writing. But mask printability and resilience to manufacturing variation are still important considerations for mask shapes output by ILT. For example, shapes that are too small or too close to each other or have too sharp a turn in the contours of the shapes make it too difficult to make the masks reliably, especially across manufacturing variation.

The energy delivered by the electrons from an eBeam machine is often approximated as a point-spread function (PSF). While there are many effects that affect how the energy is spread, in eBeam-based mask making, either for variable shaped beam or for multi-beam writing, a monotonic continuous PSF is a reasonable representation of the energy distribution. In this disclosure, for ease of comprehension, a simple single Gaussian distribution will be used as the PSF, but the embodiments apply to any suitable PSF.

When the energy is delivered across a big enough area at unit dose in a Gaussian distribution, there is ample dose for the interior of the area to reach unit dose. But if the area is small, the highest dose in the interior of the area does not reach unit dose. Similarly, if the spacing between areas is large enough, the lowest dose reaches zero. But if the spacing is small, the lowest dose does not reach zero. When either the area or the spacing between the areas is small, the dose profile is shallow. Mask manufacturing processes are designed to provide ample dose margin for a reasonable area and spacing, say 100 nm lines separated by 100 nm spaces with unit dose for a typical leading edge mask for 193i lithography. Smaller areas and spacings have lower dose margin at the contour edges of the areas. The smaller the area, the worse the dose margin, if the dose applied is unit dose.

Dose margin also becomes worse for a typical mask writing process because of proximity effect correction (PEC). Mask writing with eBeam, whether VSB, CP, or MBP, has a backscatter effect that is well known in the art. Electrons hit the resist surface, and secondary electrons released by the electrons bounce around to expose the resist in a 10 micrometer scale area around the exposed location. This has the effect of scattering, a long-range effect, and thereby partially exposing the resist in the surrounding 10 micrometer scale area. The aggregate of these partial exposures from all exposures surrounding a given area is significant enough to require correction. Software-based correction for backscatter and other long-range effects is called PEC and is typically applied in-line with the mask writer at the time of mask writing. PEC in essence decreases the unit dose of a shot (or a pixel in the case of MBP) to compensate for the aggregate pre-dosing from the surrounding shots (or pixels). Nearly all production masks are written with PEC turned on in the machine. When the dose density of a 10 micrometer scale area is high, the amount of PEC applied is also high. This has the effect of reducing the height of the Gaussian (or PSF) of the exposure, and therefore reduces dose margin at the contour edges in that dense area. Therefore, a small shape written in an area of high dose density has worse dose margin than the same sized shape written in an area of low dose density.

Dose margin matters because a shallow slope means that a given percent dose change results in a larger difference in CD. Since dose margin is known by those skilled in the art to be a good proxy for a large variety, if not a majority, of sources of manufacturing variation, measuring CD variation against dose variation is an important measure of resilience to manufacturing variation.

Mask Process Correction, which may be performed offline, pipelined, or in-line with the mask writer, may manipulate shapes or doses applied to the mask in order to correct for linearity and enhance critical dimension uniformity (CDU) and line-edge roughness (LER) among other measures of resilience to manufacturing variation. Improving CDU and LER include enhancement of dose margin, and improving the uniformity of dose margin across features in the mask. Enhancement of dose margin (edge slope) is disclosed in U.S. Pat. No. 8,473,875, “Method and System for Forming High Accuracy Patterns Using Charged Particle Beam Lithography”, which is owned by the assignee of the present application. For masks to be written with VSB or CP writers, reduction in CD split also improves CDU. A CD split is when more than one shot is used to define the opposing edges of a critical dimension feature. An example of CD split is disclosed in U.S. Pat. No. 8,745,549, “Method and System for Forming High Precision Patterns Using Charged Particle Beam Lithography”, which is owned by the assignee of the present application.

In a typical semiconductor manufacturing process, RET of step 130 in FIG. 1 produces a set of mask shapes. When a mask representation, containing the set of mask shapes, does not satisfy all desired mask constraints and characteristics, such as allowed transmission values, minimum feature size, minimum spacing, or sufficient dose margin among others, an evaluation of a mask's suitability needs to introduce terms that add a cost related to the violation of these constraints. In the field of inverse problems, introducing these terms is known as regularization. Regularization is a means of selecting a solution from a potentially infinite set of solutions that fits the desired outcome equally or similarly well but also has other a priori desirable properties. An example of ILT using regularization is disclosed in U.S. Pat. No. 10,657,213, “Modeling of a Design in Reticle Enhancement Technology,” which is owned by the assignee of the present disclosure and is hereby incorporated by reference.

Semiconductor manufacturing and submicron manufacturing in general has followed Moore's Law, which predicts that the manufacturing infrastructure advances together to allow the resolution to improve at a relatively predictable and steady rate over time. An important aspect of Moore's Law is that computational capabilities of the infrastructure scale along with Moore's Law because effects relative to power consumption and cost—such as computing bandwidth, computing speed, memory capacity, memory access speeds, communication bandwidth, communication speed, long-term storage (whether solid-state or hard-disk) capacity and speed—also scale on Moore's Law. Introduction of new manufacturing technologies such as EUV lithography or MBP-based mask writing create a discontinuity in the computing requirements. Introduction of new computational technologies such as graphical processing unit (GPU) acceleration also create discontinuity in the computing capabilities and scalability.

Computational algorithms generally scale super-linearly with complexity of the design. This means that computing a tile with 1000 elements will generally take more than twice the computing needed for a tile with 500 elements. Depending on how much longer it takes to compute a tile with 1000 elements, it may be faster to divide it into two 500 element tiles and then stitch them back together to form the 1000 element tile. However, dividing and stitching may have complications depending on the computational task and the interaction between the tiles. There is a complex tradeoff that determines the right tile size for most efficient computing. This effect is exacerbated when the amount of memory required to store sufficient information for the design far exceeds the amount of memory available on an economically feasible computing system. In data processing for chip design or chip manufacturing, or generally any device design or device manufacturing of submicron devices, full chip designs, or more generally full-scale devices, need to be divided into much smaller tiles for most computational tasks. This is because both the amount of data that needs computing and the capacity of computing scales along with Moore's Law. The results are then stitched back together both for processing by the next step and also for error and data reporting. This is called tile-based computing. The tiles are typically rectangular but may be hexagonal or a mix of different shapes and/or sizes. Calculating the wafer pattern in a tile requires inclusion of the data surrounding the tile. The surrounding data is called a halo. The halo must be large enough to capture significant effects on the predicted pattern of the tile.

### Details of Present Embodiments

Some embodiments of this disclosure produce a Continuous Tone Mask (CTM) for large sections of the mask including an entire mask layer at once. The CTM captures the values of a continuously varying amplitude transmission coefficient map, from which transmitted intensity can be calculated. For masks for 193i projection of semiconductor wafers, systems and methods known in the art on today's computing platforms do not allow producing a CTM for larger than 400-1000 square micrometer areas in wafer dimensions at once. CTM for tiles are produced, each tile with its halos independently going through an optimization loop, then stitched together to form the entire mask layer, requiring additional processing to handle stitching artifacts. In contrast, some embodiments of the present disclosure enable an entire mask layer of 7.5 square-centimeter areas in wafer dimensions to be produced together in one large optimization loop. This disclosure describes methods and systems that avoid stitching problems in a correct-by-construction fashion by iteratively optimizing entire large sections instead of iteratively optimizing tiles of large sections independently as is known in the art. A large section may be, for example, 5 microns by 5 microns. In embodiments where the large section is the entire mask, the entire mask avoids stitching problems.

Some embodiments of this disclosure also produce a corresponding Quantized Tone Mask (QTM) for tiles of the entire design, such that the tiles can be combined to form an entire mask layer. The CTM captures the values of a continuously varying amplitude transmission coefficient map, from which transmitted intensity can be calculated. In some embodiments, a CTM is converted into a QTM, which is a 2-tone mask that allows short, smooth transitions between values on a grid and effectively locates edges between grid points. The final QTM has regularized values and feature sizes. Regularization is a procedure and formulation that can bring a CTM to a QTM with the methods described in U.S. Pat. No. 7,716,627, “Solution-Dependent Regularization Method for Quantizing Continuous-Tone Lithography Masks.” In a post process, contours are extracted to obtain mask geometry from the final QTM.

Some embodiments additionally utilize a novel, more efficient data representation for the CTM and the target wafer pattern. In these embodiments, the grid points are 4 or 5 times sparser than existing measures and the data stored at each data point is minimal, yet the representation is accurate within the precision of the optical system being modeled. Added together, in some embodiments, the CTM and the target wafer pattern for the entire mask layer for optical (193i) projection of wafer lithography can be stored in the combined memory of all compute nodes of a currently commercially viable computational platform. When, in the future, EUV lithography requires ILT, a similarly commercially viable computational platform of that time can store the entire mask layer for EUV projection. ILT of EUV requires higher precision and therefore requires more memory to represent the data. In this disclosure, for ease of comprehension, the discussion uses the 193i mask situation where the entire mask layer is stored in the aggregate memory of the computing platform and is iteratively optimized together. The present disclosures are applicable for processing large sections of the entire mask layer even if the aggregate memory is insufficient to store the entire mask layer. In these embodiments, the CTM and the target wafer pattern for all tiles of the entire mask layer can be resident in memory at all times throughout processing the entire mask layer. This avoids time consuming nonresident memory access, whether solid-state drives or hard disk drives, enabling fast updates of the halo regions using distributed processing. The memory required to hold a large section is easily calculated as (X dimension/grid spacing)*(Y dimension/grid spacing)*(data size at each grid point). In some embodiments, intermediate results are only held in memory for the duration of the calculations within a tile.

Having the CTM and the target wafer function sample array for all tiles of the entire mask layer in memory at all times also enables the present embodiments to compute an optimization iteration for the entire mask layer at once, instead of optimizing each tile independently of each other, as is done in the art. As a result, the present embodiments eliminate stitching issues in a correct-by-construction manner, and compute the CTM for large sections, including entire mask layers, efficiently using a commercially viable computational platform.

In some embodiments, some MPC are performed during RET, where the mask is to be used in a lithographic process to form a pattern on a wafer.

In some embodiments, sampled values of smooth functions, which are continuous differentiable functions, on a grid and are represented in an array. In some embodiments, how well the predicted wafer pattern matches the target wafer pattern is represented as a smooth function. This technique obviates the need to find contour edges on the predicted wafer pattern and then compare them to contour edges on the target wafer pattern, as is done in most existing ILT implementations.

In some embodiments, MPC may take the ILT process down to the point where the number of areas that are left to need further optimization are few enough, and the tile containing such areas are sufficiently large to be statistically likely that optimizing those areas are not going to affect the neighbor's halo regions inside the tile. By understanding where such areas are throughout the design, a re-tiling of the design at such a stage may choose the tile size and area including potentially non-rectangular area or even curvilinear boundaries and corresponding halo regions along the perimeter.

In some embodiments, there may be iteration among different optimization strategies, for example, where the entire design is optimized all together in one strategy, and where tiles are optimized independently of each other in another strategy. The strategy may be pre-set, such as optimizing the entire design for a pre-set number of optimization iterations, then optimizing tiles until each tile meets the “cost criteria” (which may be hitting a maximum number of iterations allowed, or meeting some quality criteria, or failing to improve quality criteria sufficiently), then iterating the whole design again for another pre-set number of iterations. In another example, the strategy may be adaptive to some set of criteria observing the state of the mask design and the global and local optimization progress including the rate of change, and the rate of change of the rate of change, of the optimization criteria with various strategies being deployed with different parameters and potentially also different tiling as the ILT process proceeds.

Function Sample Arrays

The goal of RET is to create a mask such that the energy in the substrate is below a threshold everywhere that the substrate should be clear (or dark if negative resist is to be used), above the threshold everywhere the substrate should be dark (or clear for negative resist), and transition through threshold at the desired locations. In some embodiments, smooth functions are used to represent clear areas, dark areas, and transition locations. Smooth functions are continuous and differentiable. The smooth functions are captured on a grid sufficiently fine to define the functions within a tolerance. The array of values representing a smooth function shall be referred to in this disclosure as a Function Sample Array (FSA), which is an array of real, or possibly complex, values of the underlying function at sampling locations. In some embodiments, smooth functions are implemented as band limited functions, which are by nature infinitely differentiable. A band limited function is a function that only contains frequency components within a fixed limit as opposed to a theoretically infinite number of components. The nature of the band limited functions determines the sampling rate (grid spacing). The present embodiments uniquely recognize that light emanating from the mask and of the energy absorbed by the substrate are naturally represented by smooth functions. The target wafer pattern, the predicted wafer pattern, and the CTM are modeled as FSAs.

Leveraging knowledge of the optical lithography allows smooth functions to be chosen, such that the exact function can be defined on a grid much coarser than used in existing RET methods. The lithographic imaging resolution is based on a wavelength and a numerical aperture of the lithographic imaging system. In the present embodiments, an FSA grid has a plurality of grid points, and the grid points are spaced at a grid pitch. The grid pitch may be set by choosing a transition distance that is less than the lithographic imaging resolution of the lithographic imaging system and dividing the transition distance by a value such as from 3 to 6 or may be set based on pre-defined edge placement error specification. The determining factor on the divisor is the accuracy required when determining where the function crosses the threshold. The key to these embodiments is that the smooth function is accurately captured by its values at the grid points. This means that the predicted wafer pattern grid points can be compared directly to the target wafer pattern grid points without having to compute the exact location of the mask pattern contours. The ability to accurately represent a pattern with limited number of samples enables the computation of large tiles with less memory and higher speeds than conventional methods. This enables fast, exact, and distributed computation—which can, for example, be GPU-based—of differentiable cost functions that measure the degree of shape matching.

The present embodiments form grids based on the lithographic imaging system physics for all stages from the CTM to the target pattern FSAs and have the ability to resample reliably onto finer grids. Because of this, the present embodiments can work on large areas in a single compute node. Further, the present embodiments decompose computations of extremely large areas such as an entire mask layer for 193i masks into tiles without stitching artifacts. These possibilities have not been obvious to the reticle enhancement technology industry since there are multiple stumbling blocks to address, such as accurate grid-based pattern representation without ultrafine grids, and reliably interpolating to finer grids on the fly. For example, instead of using a 1-4 nm sampling grid for an RET of 193i lithography as is typical in the prior art, in the present embodiments a sampling grid of 8-10 nm scale can be used. This enlargement of the grid sampling saves 5× to 100× or more in required memory.

The FSA for the target wafer pattern is generated from the input target pattern. The FSA for the predicted wafer pattern is generated from the CTM using a lithography system model. The predicted wafer pattern FSA is massaged to have characteristics similar to the target pattern FSA, such as values near 1 inside a shape, near 0 outside a shape, and with smooth transitions between these regions. This massaging prevents a value of 0.15 in the predicted pattern being a mismatch for a value of 0.0 in the target pattern in clear (or dark in negative resist) areas. The only values that are critical are where the function transitions through the threshold. Therefore, when the values at the grid points of the predicted wafer pattern FSA match the values of the target wafer pattern FSA, the mask will accurately create the desired pattern on the substrate. The smooth function representations that are in an FSA support optimizing values without any explicit knowledge of edge locations in the target wafer pattern.

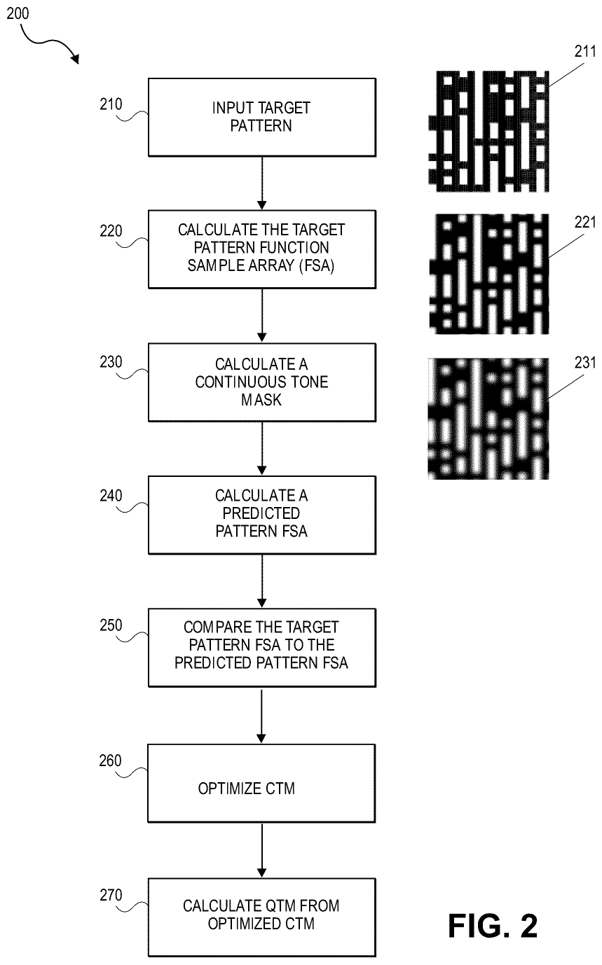

FIG. 2 is an example flowchart 200 of a method for reticle enhancement technology in which smooth functions are captured in FSAs and used for a target pattern and for a mask that is to be used to produce the target pattern (e.g., a target wafer pattern). For example, flowchart 200 describes methods for representing a target wafer pattern or a predicted wafer pattern as a smooth function captured as a FSA, where the FSA is an array of function values which can be real numbers, complex numbers, or an aggregate of numbers. In step 210, a target pattern to be used in reticle enhancement technology, such as pattern 211, is input. The target pattern 211 can include many patterns of a design (e.g., the individual rectangular and square patterns in target pattern 211) as shown in FIG. 2, such as an entire mask layer of a semiconductor chip or can be a single pattern to be written onto a surface. Next in FIG. 2, a target pattern FSA for the target pattern is calculated in step 220. The generating of the target pattern FSA in step 220 can, in some embodiments, include applying a low-pass filter to the target pattern. The target pattern function is pictorially represented as function 221 in FIG. 2, where function 221 is slightly blurred compared to target pattern 211. The target pattern function 221 is band-limited to a bandwidth of the low-pass filter, and the target pattern is sampled on a pattern grid having a first sampling rate that may be at least twice the bandwidth of the low-pass filter. The low-pass filter bandwidth may be set to maintain edge locations and to allow rounding of corners consistent with the lithography system characteristics or a specification provided with the target pattern.

In step 230, a CTM 231 is calculated. The CTM 231 can be initialized with a first guess, such as a constant value, a low-pass filter applied to the target pattern, a previously determined CTM (e.g., a preliminary result previously computed), or a low-pass filtered mask obtained through other means (e.g., when addressing a hot spot in an existing mask design or examining a solution provided by another system).

In step 240, a predicted pattern FSA (representing a predicted wafer pattern) is calculated from the CTM and the system models.

In step 250, the target pattern FSA is compared to the predicted pattern FSA computed for the CTM. Comparison of the target pattern FSA and the predicted pattern FSA uses grid points of the pattern grid. The comparison may include calculating a cost density function using the target pattern function and the predicted pattern function. The predicted pattern function (FSA) may be generated using the CTM, a lithographic imaging system model, and a resist process model.

Step 260 for the present embodiments involves an optimization technique for the CTM of iterating on a proposed solution until the cost is reduced to as close to 0 as possible when the values at the equivalent grid points are compared for the predicted pattern FSA and the target pattern FSA.

In step 270, when the desired result is achieved, the proposed solution is captured as an optimized CTM, which is further regularized and transformed into a QTM.

Optimizing the CTM

The present embodiments utilize an optimization technique of iterating on a proposed solution until the desired result is achieved. The proposed solution is captured as the CTM, which is later transformed into a QTM in some embodiments. The measurement of the desirability is determined by comparing the FSAs for the predicted pattern and the target design pattern. The comparison of the FSAs involves comparing, perhaps within some tolerance, the values at the equivalent grid points representing the two functions. The goal of the process being described is to reduce the cost as close to 0 as possible. Other techniques are possible to converge using different cost metrics.

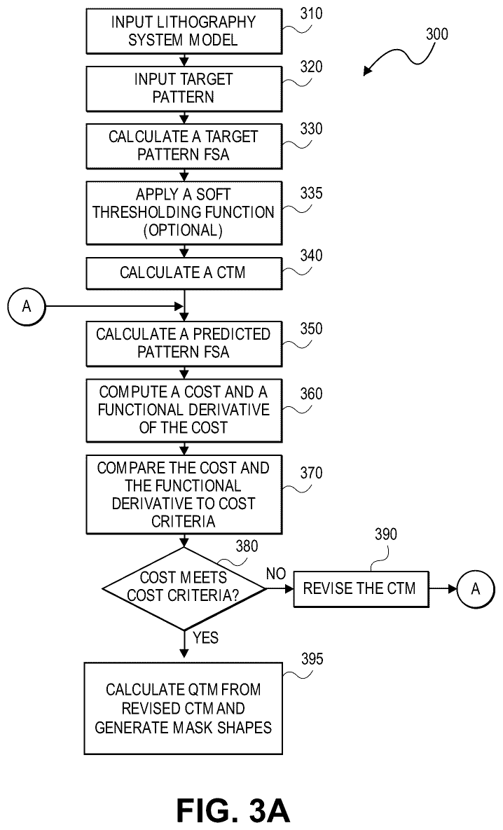

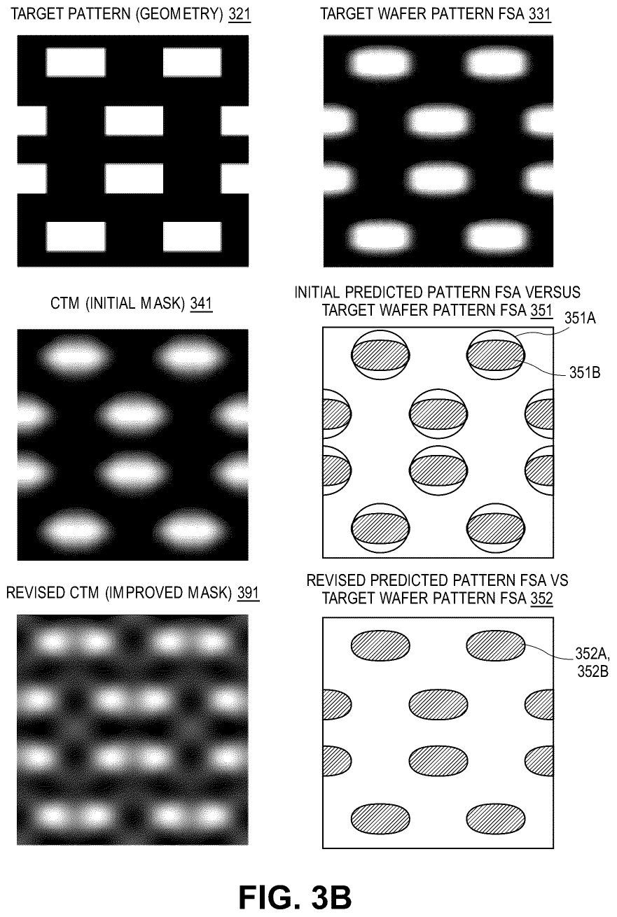

FIG. 3A is an example flowchart 300 of a method for reticle enhancement technology in which FSAs are used for all steps involved with generating optimized mask shapes from the CTM in the form of a QTM that will be used to produce a pattern on a substrate. In step 310, a substrate lithography system model, such as for wafer lithography, is input. The substrate lithography system model includes one or more of an optical, EUV or other lithographic system model, a resist process model, and any other models needed to predict the printed pattern on the substrate resulting from a mask. A model included in the substrate lithography system model may be a complex, physically accurate model, a simpler empirical model, or any other level of model according to a specification, including a null model that removes most or all its effects on a final result. The substrate imaging system model can include parameters such as wavelength, illumination pattern, numerical aperture, refractive index, and so on.

Step 320 includes inputting a target pattern (e.g., a target wafer pattern) to be formed on the substrate using the substrate lithography process, the target pattern being within a design area. In some embodiments, the target pattern comprises a plurality of patterns on a wafer, and the design area may comprise an entire mask layer or a large section of a mask layer of a semiconductor chip. In step 320, in some embodiments of the present disclosure, certain geometric manipulations of the target pattern may be performed. For example, edge bias that accounts for etching effects during the processing of the substrate may be precomputed prior to the optimization steps in steps 330 and later.

In step 330, a target pattern FSA is calculated for the target pattern, such as a target wafer pattern. In some embodiments, the calculating of the target pattern function includes applying a low-pass filter (which may also be referred to as a blurring) to the target pattern. The low-pass filter may be, for example, a Gaussian, or any other filter that is well-localized in space and frequency.

In step 340, a CTM (i.e., a proposed mask) is calculated, as explained in relation to step 230 of FIG. 2.

In step 350, the substrate lithography system model is used to calculate a predicted pattern FSA that will be produced on the substrate by the CTM. In some embodiments, the calculation of the predicted pattern FSA (e.g., a predicted resist pattern function) can include calculating a projected image function from the CTM, using the substrate imaging system model. The projected image function and a resist process model are then used to calculate the predicted pattern FSA produced by the projected image function. The calculating of the projected image function may utilize a localized Fourier interpolation to go to a finer grid according to the needs of the calculation method or of subsequent use of the projected image.

In step 360, a cost is computed using the target pattern FSA and the predicted pattern FSA, and a functional derivative of the cost with respect to the CTM is also computed. The cost may be, for example, a total cost. The cost can be represented by a smooth function. In some embodiments, the costs may be global cost data, which can include, for example, local partial costs, cost densities, and cost gradients. In some embodiments, the computing of the functional derivative accounts for neighboring pattern information in a boundary area surrounding the design area. In some implementations, the computing of the cost includes calculating a cost density function using the target pattern function and the predicted resist pattern function and integrating the cost density function over the design area. The calculating of the cost density function can include squared differences between the target pattern function and the predicted resist pattern function, absolute values of these differences, or any formula that produces positive values that tend to zero where the patterns match and to larger numbers where they do not. These cost density values may also be weighted according to other information provided with the target pattern or derived from the target pattern. For example, the weights may be used to emphasize fitting edges and deemphasize matching corners.

In step 370, the cost and the functional derivative are compared to cost criteria. In other words, this comparison determines a mismatch between the predicted and desired patterns. The cost criteria can include converging the cost to a value near a minimum, or minimizing the magnitude of the functional derivative, or its components. That is, the cost criteria can be deemed to be met when further iterations do not vary from previous solutions by more than a certain amount. The cost criteria in some embodiments can include evaluating a distribution of values of the cost density function over the design area. The cost criteria can also be defined as an amount of mismatch, for example, a specified acceptable amount, such as a geometrical value or a percentage.

Note that in flowchart 300, variations are possible. For example, steps 310 and 320 are interchangeable in sequence. Step 330 can be a null-step in some embodiments of the present disclosure. Steps 340 and 350 may be combined in one step. In steps 360 and 370, computing the derivative is optional. Other computations could be done in steps 360 and 370 to help iteration on the CTM.

In some approaches, a target pattern function with more distinct edges can be generated prior to the computing of the cost of step 360, by applying a soft thresholding function in step 335 to the target pattern function to sharpen the edges of the target pattern function. The soft-thresholding turns the encoded patterns into higher resolution functions that are featureless away from the edge transitions, thus giving more weight to the contours without the need to determine them directly. This allows the target pattern function to be stored at lower grid resolution than when used for making comparisons. The cost, such as a total cost, is computed in step 360 using the target pattern FSA after any applied sharpening and the predicted resist pattern function.

In an example of thresholding the target pattern FSA, the target pattern FSA in step 330 is generated by applying a low-pass filter to the target pattern, such that the target pattern function is band-limited to a bandwidth of the low-pass filter. The target pattern function is sampled on a first pattern grid having a first sampling rate that may be at or higher than the Nyquist rate for this bandwidth, and the thresholded target pattern function that is generated in step 335 is sampled on a second pattern grid having a second sampling rate that is higher than the first sampling rate. The soft thresholding function may be, for example, a sigmoidal function that sharpens transitions between minimum and maximum values in the target pattern. For example, the slope of the thresholded target pattern function may be increased in transitions between minimum and maximum values in the target pattern, thus sharpening the edges of the target pattern function.

Soft thresholding enables the function to more closely conform to results of the predicted resist pattern function. Soft thresholding can be implemented as mapping 0 to “0” (soft range), 1 to “1”, a threshold value to a threshold value (e.g., ½ to “½”); and can be implemented as a smooth, monotonically increasing switching function based on the Gaussian error function, the hyperbolic tangent, or any other sigmoidal function one of ordinary skill may devise. In some embodiments, this first soft thresholding function can also be applied to the predicted resist pattern function to generate a second predicted resist pattern function for comparison to the target pattern.

Returning to step 380 of FIG. 3A, if the cost criteria are not met, the method is iterated as indicated by step 390 by revising the CTM to reduce the cost, using the functional derivative of the cost to provide direction on how to revise the mask. This will use the derivative calculations and use any suitable algorithm such as conjugate gradient to pick a “direction” to move from the current mask parameters to lower the cost. The cost, or partial contributions to the cost, may be used explicitly in this process, or the gradient components, or both. In some embodiments, steps 360 and 395 include calculation of the mask shape's printability and resilience to manufacturing variability to be used as a part of the optimization cost. Size, spacing, and slope of CTM at a certain threshold or multiple thresholds of CTM are examples of components in such a cost. Steps 350, 360, 370, 380 and 390 would then be repeated as indicated by loop “A” until the cost criteria are met. Revision of the CTM for each iteration could consider further factors in addition to the functional derivative, such as historical data on previously calculated solutions. The final CTM is then output in step 395. In step 395, the CTM data may then be “legalized” into a more reliably manufacturable mask pattern such as a QTM. This process may involve reducing hot spots, measuring CD variation against dose variation, correcting for linearity and enhancing critical dimension uniformity (CDU) and line-edge roughness (LER) among other measures of resilience to manufacturing variation. In some embodiments, step 395 includes a separate step to produce a more reliably manufacturable mask. An example of such a step is to force all shapes and spacings to “snap” to adhere to a prescribed minimum. By incorporating these factors as costs during the optimization loop in step 360, the amount of snapping will be negligible with negligible impact on the resulting quality in the predicted pattern FSA. These mask patterns may also further be processed to incorporate some MPC of mask manufacturing effects such as mask etch bias. In the present embodiments, step 395 may include all MPC and the creation of a QTM, a 2-tone mask that effectively locates edges of manufacturable mask features between grid points on the CTM. In some embodiments, this process can involve a total cost system to penalize masks that cannot be made, while optimizing to both reduce manufacturing penalty and retain good wafer results. In some embodiments, a cost function for mask value regularization can be used as a method to convert a CTM into a QTM. In some embodiments, a cost function for mask feature size regularization can include a preference for mask features that can be created with fidelity and control. The final QTM has regularized values and feature sizes, like rasterized shapes. The output of the legalization step may be in the form of data to drive one of a range of charged particle beam technologies, such as to generate exposure instructions directly from the CTM or from a QTM that has been translated from the CTM.

FIG. 3B provides example illustrations of the steps described in flowchart 300 of FIG. 3A. Target pattern geometry 321 is an example of a target pattern that is input in step 320, where target pattern geometry 321 in this embodiment includes several rectangular shapes. Target wafer pattern FSA 331 corresponds to the target pattern function that is generated in step 330. An initial CTM 341 is generated in step 340, and an initial predicted pattern FSA 351A is produced by the initial CTM 341 in step 350. Diagram 351 illustrates the initial predicted pattern FSA 351A as open curvilinear shapes, and the target wafer pattern FSA 351B as cross-hatched shapes. The difference, between the initial predicted pattern FSA 351A and the target wafer pattern FSA 351B, as illustrated in diagram 351, is used to compute a cost and a functional derivative of the cost in step 360. If the cost criteria are not met in steps 370 and 380, a revised (improved) CTM 391 is calculated in step 390. Loop A is then iterated, in which a revised predicted pattern FSA 352A is calculated in step 350 using the improved CTM 391. Similar to diagram 351, diagram 352 illustrates a difference between the revised predicted pattern FSA 352A and the target wafer pattern FSA 352B. No open shape can be seen, indicating that the revised (and improved) predicted pattern FSA 352A is sufficiently close to the target wafer pattern FSA 352B that the difference is not visible in diagram 352. The difference between the improved predicted pattern FSA 352A and the target wafer pattern FSA 352B is used to determine if the cost criteria are met. Note that in FIG. 3B, the functions are depicted as conventional contours of geometric shapes, where the contours are illustrated at a resist exposure threshold level in this example. These contours illustrate how the pattern shapes are improved using the present methods. However, as explained throughout this disclosure, some embodiments of the present methods perform computations using FSAs rather than working with the geometric contours.

Legalization

In the present disclosure, a CTM can be transformed to a reliably manufacturable mask. Modifications can be made to the CTM and/or to the QTM to ensure that the mask is manufacturable.

In some embodiments, the iterative optimization of the CTM uses costs related to reliable manufacturability of the mask shapes. In some embodiments, a set of constraints related to reliable manufacturability of the mask shapes prohibit certain shapes to be considered. In some embodiments, after the cost criteria is met, mask shapes may be further modified to fit the exact specifications for mask manufacturability. Costs and criteria for mask manufacturability include, but are not limited to, minimum size and spacings, maximum curvature allowed, minimum dose margin and mask edge error factor (MEEF). Optimization of MEEF and other factors are disclosed in U.S. Pat. No. 8,719,739, “Method and System for Forming Patterns Using Charged Particle Beam Lithography,” which is owned by the assignee of the present application.

The CTM has a continuous range of values that must be converted to contiguous regions of allowed transmission values. The contiguous regions of fixed transmission value correspond to shapes on a manufacturable mask. The allowed transmission values depend on the type of mask; for example, they are conventionally 0 or 1 for a chrome-on-glass mask, or −\sqrt{0.06} and 1 for a 6% attenuated phase shift mask.

In an embodiment, this conversion is accomplished through regularization, which involves adding terms to the cost or cost function, that favor manufacturable masks.

The primary regularization needed is to favor masks that are very close to the allowed transmission values everywhere, with a possible exception for transitions from one allowed value to another, which may contain intermediate values. In an embodiment, a term, which shall be referred to as a “value-shaping term,” is introduced that favors the allowed values and favors short transitions between a region of one value to a bordering region of another value.

A CTM that is selected using a value-shaping term in the optimization may contain shapes that will be difficult to manufacture reliably. In an embodiment, a second value-shaping term is introduced that favors shapes that will have good dose margin when manufacturing the mask. Such a term may use a PSF to measure how much the shapes change and compute a cost based on the changes.

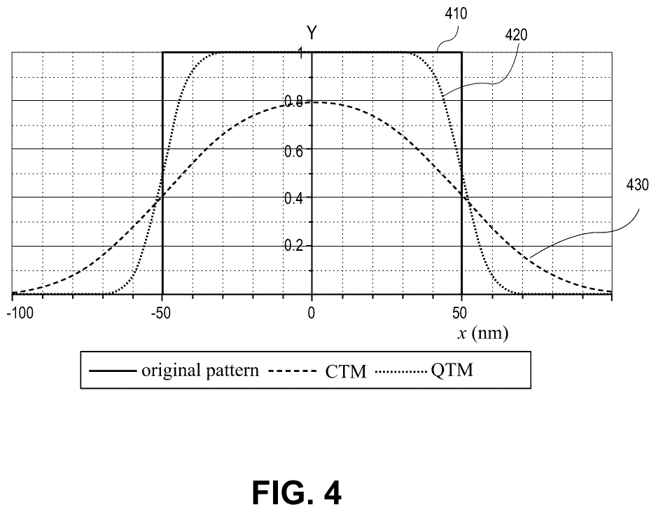

A large set of theoretical masks can provide good lithographic results on a wafer. Regularization selects from the subset of masks that can be manufactured, with a preference for those that can be reliably manufactured. A total cost system can be utilized to penalize masks that cannot be made while optimizing to reduce manufacturing penalty and while retaining good wafer results. FIG. 4 shows the relationship between the CTM 430, QTM 420, and an ideal two-tone mask 410. In some embodiments, FIG. 4 compares the soft curve of a CTM (represented by the slope of CTM curve 430) with a QTM (represented by the slope of QTM curve 420), which is a 2-tone mask that allows short, smooth transitions between values. In this example, the QTM transitions from 0 to 1 in tone value in a short space (from x=−70 to −30 nm, and from x=30 to 70 nm). By comparison, the CTM never achieves a tone value of 1, and the transition from 0 to 0.8 in tone value for the CTM is continuous over a longer space (from x=−100 to 0 nm, and from x=0 to 100 nm). While it is computationally efficient, the grayscale CTM is not printable and must be converted to a printable mask. In the example shown in FIG. 4, the conversion from a CTM to a QTM effectively locates edges at a tone value of 0.5 to establish printable mask geometries from the grid points of the optimized function sample arrays. The short, smooth transitions between mask tones indicative of the QTM are reflected in QTM curve 420 of FIG. 4. By contrast, the longer, more continuous transitions indicative of the CTM are reflected in CTM curve 430 of FIG. 4. In some embodiments, a cost function for mask feature size regularization can include a preference for features that can be created on a mask with fidelity and control. In practice smooth functions are used, but the main difference may be peak values in the middle of small features. The final QTM has regularized values and feature sizes, like rasterized shapes. Regularization includes extracting contours to get geometric shapes for the mask by applying a sharp threshold to the QTM. Once the contours are extracted, MRC can be accomplished, and optimization based on MRC can be achieved.

Distributed Processing

An aspect of the present embodiments is the combination of data representations as FSAs as captured on a regular grid, which efficiently delivers and receives data from each process of a distributed process.

As stated previously, in order to predict the mask pattern for the CTM and compare the predicted wafer pattern that the CTM produces to the target wafer pattern, the present embodiments decompose the design into tiles, or large sections of the mask layer. Although the present embodiments of optimizing an entire design through distributed processing shall be described first in terms of a CTM and finally as a QTM, the embodiments can also be applied to types of proposed masks other than the CTMs and QTMs described herein. In some embodiments, the proposed mask for a single tile, first represented as a CTM and later represented as a QTM, and the corresponding target wafer pattern for that section of the design are held in memory on a single node.

Segments of the FSA can be sampled at a higher rate when computations are being performed on specific tiles within the entire design. For example, the entire pattern can be divided into a plurality of tiles, and calculations on the plurality of tiles are performed in distributed processes. Distributed processes operate independently, and many processes can run at the same time. In some embodiments, a single tile is processed on a compute node of a computing cluster. That cluster may hold other nodes operating on other tiles in parallel. In any tile of the plurality of tiles, the CTM, the predicted pattern FSA that it produces, and the target pattern FSA are delivered at the design-wide grid spacing, but when more detailed calculations are required, the values of the FSAs can be calculated at any spacing. The results of the distributed process are returned on the design-wide grid spacing. That is, the sampling rate can be increased for higher resolution calculations when computations are being performed on a particular region of the tile, but the additional values (higher sampling rate) of the FSA do not need to be stored in memory during the computation of the entire pattern. This saves memory and enables an entire mask layer to be computed in tiles using independent distributed processes. The up-sampling may be performed by taking the discrete Fourier transform via Fast Fourier Transform (FFT) algorithms, extending the transform to higher frequencies corresponding to the higher sampling rate via periodic extension, multiplying the result by the low-pass filter in frequency space corresponding to the ideal filter multiplied by a localizing Gaussian in real space, and applying the inverse discrete Fourier transform via FFT algorithms. Stitching errors between tiles can be reduced to the point of elimination by adding more to the boundary of the tiles so that the mismatch occurs a prescribed number of Gaussian widths away from the tile edge. The foregoing describes the use of a Gaussian localizing factor, but other forms that limit spatial extent may be suitable as known to one skilled in the art. The sampling rates are also set higher than the Nyquist minimum rate so that the function bandwidth stays within the flat part of the filter in frequency space and to a prescribed accuracy.

The present methods enable graphical processing unit (GPU) acceleration due to regular grid-structured computations. The FSAs are conducive to GPU computations because many grids can be processed simultaneously. The computations involve single instruction, multiple data (SIMD) operations, with no contour-chasing. Exact function resampling is achieved via highly optimized FFTs. GPU computation time is greatly reduced due to reduction in data transfer time, since the amount of grid sample data that needs to be held in memory is based on using only the coarsest grid necessary to exactly represent the functions, and because in some embodiments the iterations associated with each tile can be computed on a compute node comprised of one or more GPUs. The minimization of data transfer to/from the GPU is important because a GPU is extremely fast at computing but typically limited by its data transfer rate. The present methods increase the area of a tile that can fit in a given memory size by 4 to 10 times compared to conventional methods, with a corresponding 5× to 10× reduction in overhead and 5× to 10× reduction in seams between tiles.

Use of localized Fourier interpolation via FFTs and a localization function that confines the effects of mismatched boundaries to a specified distance allows computations to operate on whatever resolution grid is most appropriate, and only store quantities that persist through the optimization on their minimum grids. Without this, the memory requirements become impossible to meet for calculating a mask layer for an entire tile on a single node. Another benefit of the present methods is that the computation of the cost function and its derivatives is distributed using large tiles with sufficient overlap to allow for the lithographic imaging proximity range and the localized Fourier interpolation range, while still optimizing all the mask parameters over the entire tile without stitching artifacts when the tiles are reassembled.

In some embodiments, using decomposition into tiles with their respective halos, independent evaluation of each tile's contribution to the cost functional and derivatives can be performed, and the benefits of band-limited, smooth functions allow a single node to hold values for a large design area due to memory efficiency. Tiling the entire design also enables computation acceleration, such as using GPUs, which is further enabled by regular grid-based computations and leverage from FFTs as needed.

Optimizing the Entire Design

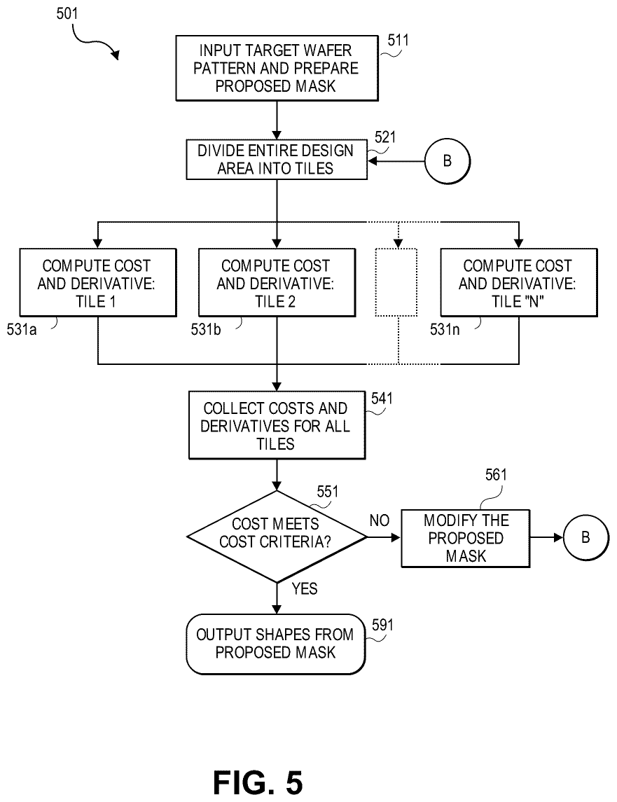

In FIG. 5 of the present methods for reticle enhancement technology, the entire design iterates over an optimization loop. In every loop iteration, the data for each tile's halo is refreshed from the adjacent tiles. Therefore, there will be no discrepancies in the data being processed by adjacent tiles, avoiding stitching errors or the need to resolve them. In step 511 of flowchart 501, for example an entire target wafer pattern is input and a proposed mask, such as a continuous tone mask (CTM), is prepared. The design for the entire target wafer pattern may be, for example, an entire mask layer of a chip design. The target wafer pattern spans an entire design area. In some embodiments, the target wafer pattern and corresponding proposed mask in step 511 may each be represented as a function sample array. Step 511 corresponds to steps 320, 330, and 340 of FIG. 3A. In step 521, the entire design area is divided into a plurality of “N” tiles. The proposed mask, such as a CTM, of the entire design area is iterated as indicated by loop “B” in FIG. 5, where in an iteration, each tile is computed independently from any other tile. The proposed mask of FIG. 5 may be the proposed solution from step 260 of FIG. 2. The computing of each tile and its halo region in steps 531a, 531b, through 531n, includes computing a cost and derivative data for each tile. Step 531a/b . . . n corresponds to steps 350 and 360 of FIG. 3A. The cost and the derivative data are based on comparing the target wafer pattern and a predicted wafer pattern that will be produced by the proposed mask (e.g., CTM). All tiles are computed in a distributed process on a computing cluster.

Each iteration also includes step 541 of collecting the costs and the derivative data for all tiles in the plurality of tiles to calculate a cost for the entire design area. In some embodiments, the collected costs include costs for reliable manufacturability of the mask as discussed in step 360 and 395. If the cost does not meet the cost criteria in step 551, the costs and the derivative data are further iterated to modify the proposed mask in step 561. Step 551 corresponds to steps 370 and 380 of FIG. 3A, and step 561 corresponds to step 390 of FIG. 3A. The process is then iterated as indicated by loop B. In step 591, after the cost has been determined to meet the cost criteria, the proposed mask is converted to contoured shapes which are output to a mask for the entire design such as a QTM. Further processing of mask shapes for reliable manufacturing of masks, for MPC, or for format output as described in step 395 apply to step 591. Variations on the process depicted in FIG. 5 include: (1) in some iterations, not optimizing tiles which have met optimization criteria and are known to have not had their halo data change; (2) re-tiling the design and/or proposed mask after a criterion has been met, such as a number of tiles meeting optimization criteria or a number of iterations have been performed; (3) using different optimization techniques for some of the iterations; (4) only optimizing tiles that have high cost for a few iterations before continuing to optimize the entire design.

In some embodiments, each tile has a halo region surrounding the tile; the calculating is calculated for every tile and its halo region; and each iteration further includes updating the CTM for an individual tile in the subset of tiles, after calculating the predicted wafer pattern, and using the updated CTM for the individual tile to update the halo regions of tiles that neighbor the individual tile. In certain embodiments, the halo region for a tile in the plurality of tiles has a thickness surrounding the tile that is as small as 1.5 to 4 times a lithographic imaging proximity range cutoff of a substrate lithography system for the RET.

In some embodiments, the calculating of every tile is performed on a computing node accelerated by a graphical processing unit. In some embodiments, the representing of the target wafer pattern as a FSA includes applying a low-pass filter to the target wafer pattern. In some embodiments, the FSA for the target wafer pattern is band-limited to a spatial frequency cutoff of a substrate lithography system, and optionally may be sampled on a grid that meets a Nyquist criterion. In some embodiments, the target wafer pattern is for a mask layer of a semiconductor chip.

Seeding the Proposed Mask with Deep Learning

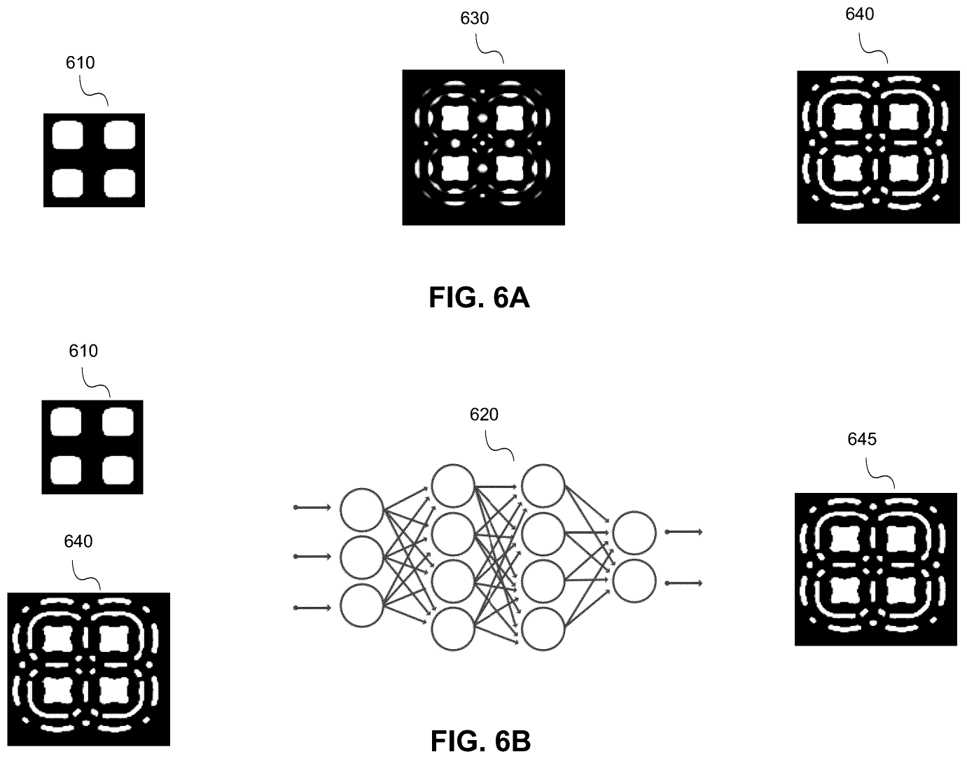

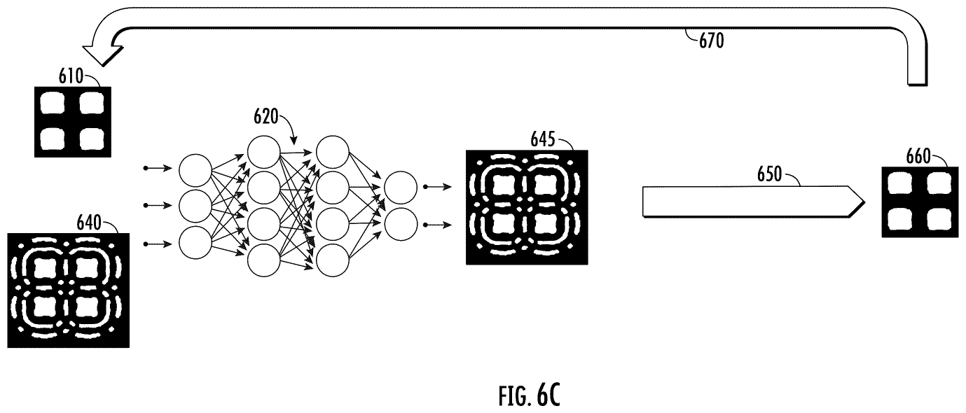

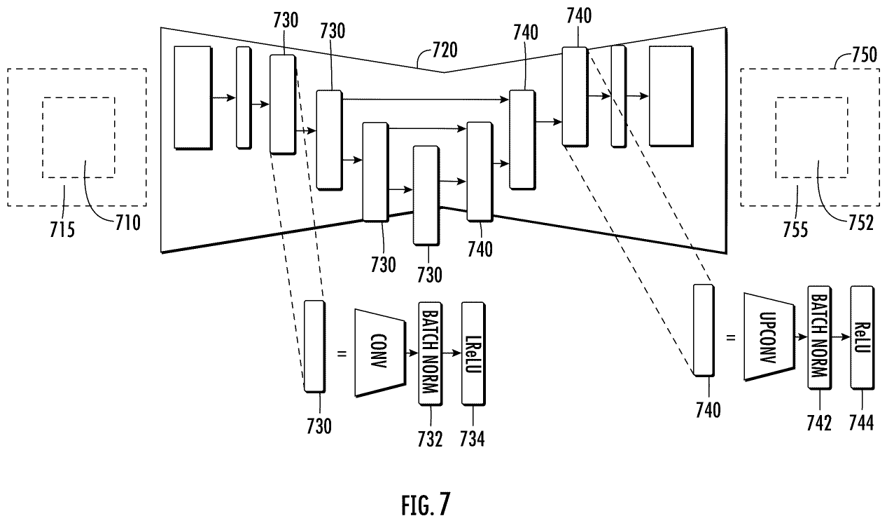

FIGS. 6A, 6B and 6C illustrate a training method for generating a proposed mask or a QTM. In some embodiments, an optimized mask 630 for the target pattern 610 may be calculated as in the flow 200 of FIG. 2, step 260. After the optimized mask 630 is calculated, a step of legalization may include calculating an optimized QTM 640 from the optimized mask (as in step 270 of FIG. 2).

In a deep learning neural network 620 (FIG. 6B), the target pattern 610 and its corresponding optimized mask or QTM 640 are input and the deep learning neural network 620 is trained to generate an optimized mask or QTM 645. The generated optimized mask or QTM 645 may then be further optimized. Once trained, using the deep learning neural network 620 to generate the generated optimized mask or QTM 645 can be performed faster than step 260 of FIG. 2. FIG. 6C, which is similar to FIG. 6B, shows the target pattern 610 and its corresponding optimized mask or QTM 640 that are input to train deep learning neural network 620 to generate an optimized mask or QTM 645. A lithography simulation step 650 then uses optimized mask or QTM 645 to produce a wafer pattern 660. In some embodiments, a verification step 670 shown in FIG. 6C may include using QTM 645 and lithography simulation step 650 to produce a wafer pattern 660 that can be compared to the target pattern 610.

Training data is not repetitive (unlike designs) and includes many variations on a pattern, e.g., rotations and sub-pixel translations as well as data intentionally below a minimum feature threshold for learning boundary conditions. In some embodiments training data includes sweep-based patterns with varying width and spacing. In other embodiments, training data includes constrained random patterns with varying angle, width and spacing. Each pattern in the training data includes a halo to allow for sample points to go beyond the data boundary.

FIG. 7 illustrates an example neural network that can be trained to infer (i.e., generate) an optimized mask or QTM from a plurality of tiles of a target pattern. The network includes a U-net 720. The single tile and its halo are divided into a plurality of subtiles. The subtile 710 in this example is 512×512 pixels surrounded by a halo 715 with a width of 256 pixels, which are input to the U-net 720. In this example, the U-net 720 contains 4 convolutional layers 730 each followed by a batch normalization layer 732 and a leaky rectified linear unit (LReLU) 734. The U-net 720 also contains 3 de-convolution or up-convolution layers 740 each followed by batch normalization layer 742 and rectified linear unit (ReLU) 744. The U-net 720 outputs a predicted mask, or QTM 750 which in this example includes a tile 752 of 512×512 pixels surrounded by a halo 755 with a width of 256 pixels. The QTM 750 is optimized from all the tiles of the target pattern, each tile divided into subtiles and then input in the next neural network iteration. Because the halos are updated during the processing of all the tiles, the inferencing (i.e., calculating or generating) of the optimized QTM 750 is always up-to-date per subtile/tile.

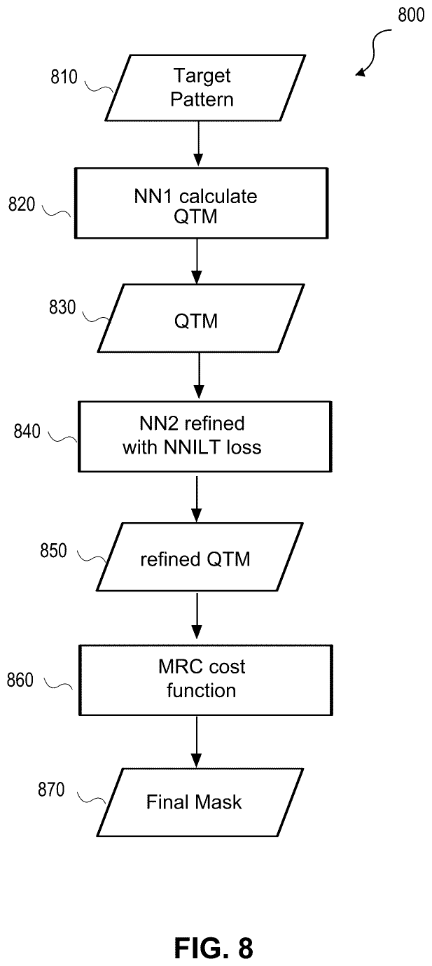

The predicted mask or QTM 750 that is output in FIG. 7 is different from the QTM calculated in step 270 of FIG. 2. In FIG. 2, QTMs are calculated from function sample arrays, and these QTMs are used to train (i.e., seed the training process of) the neural network of FIGS. 6-7 (and FIG. 8, described below). Thus, although the QTM of step 270 and the QTM 750 are both used in producing the same mask, the QTM of step 270 is generated using function sample arrays whereas QTM 750 is generated/inferred by a neural network that has been trained with the QTMs of step 270 (and using QTM 640 and generated optimized mask QTM 645 during the neural network training process).

FIG. 8 illustrates a flow 800 including a set of deep learning neural networks trained to generate a QTM (e.g., trained as described in relation to FIGS. 6A-6C and 7), in a method for reticle enhancement technology. A target wafer pattern 810 is input to flow 800, the target wafer pattern spanning an entire design area. An entire design area of the target wafer pattern 810 may be divided into tiles, each tile having a halo region surrounding the tile. A tile of the target wafer pattern 810 is divided into subtiles and input to a first trained neural network 820 indicated as “NN1” (neural network 1). The first neural network 820 is pre-trained with mask rule check (MRC) aware masks. An initial tile of a proposed mask 830 (optimized mask, such as a QTM) is calculated by the first trained neural network 820 using the tile of the target wafer pattern 810. That is, flow 800 involves calculating an optimized mask (proposed mask 830), wherein the optimized mask is generated by the first trained neural network 820 using the target wafer pattern 810. The proposed mask may be calculated (performed) for each tile in the plurality of tiles including its halo region. The tile of the proposed mask 830 (e.g., QTM), which may contain SRAFs, is input, subtile by subtile, to a second trained neural network 840 indicated as “NN2” (neural network 2). Some embodiments include retraining the first trained neural network 820 to create the second trained neural network 840, wherein the second trained neural network 840 generates a refined QTM from the QTM.

In an embodiment, the architecture for each of the trained neural networks 820 and 840 are the same. However, during training each neural network system may use different loss functions. The training method shown in FIGS. 6A-6C may be used for both neural networks. In an embodiment, the first trained neural network 820 may be trained with image loss which may use root mean square error (RMSE) or mean square error (MSE). In an embodiment, the image loss may be a combination of L1 and L2 losses. In another embodiment, the image loss may include a hinge loss. A refined QTM 850 is calculated by the second trained neural network 840. The second trained neural network 840 may be trained with a loss function (e.g., “neural network inverse lithography technology” NNILT loss shown in FIG. 8) to generate the refined QTM. The loss refinement may include improving CD variation by checking that the nominal dose produces an edge closely matching the target for all process or manufacturing conditions. The process conditions may include dose and focus band.

In an embodiment the optimization may include MRC. The QTM may be used to generate a predicted wafer pattern during optimization; i.e., the retraining may further comprise calculating a predicted wafer pattern using the refined QTM. Then in a post-process step 860 the refined QTM 850 is corrected for MRC using flowchart 300 with an MRC gradient cost function similar to cost function in steps 360 and 370 in flowchart 300 of FIG. 3A. The MRC gradient cost function of step 860 is optimized to fix MRC violations. A final mask 870 is output from step 860, where the final mask 870 is a mask rule checked QTM. Step 860 involves generating final mask 870 using a cost function (e.g., MRC and/or MRC gradient), wherein the generating is performed as a post-process. In an embodiment, the refined QTM 850 may be used to train a third neural network to generate the final mask 870. In an embodiment, a loss function used to train the third neural network may include an MRC gradient loss.

The first trained neural network 820 and second trained neural network 840 may comprise a U-net, such as described in FIG. 7.

Computation Systems

The computation and processing steps described in this disclosure may be implemented using general-purpose computers with appropriate computer software as computation devices. Multiple computers or processor cores may also be used in parallel. In some embodiments, a special-purpose hardware device, either used singly or in multiples, may be used to perform the computations of one or more steps with greater speed than using general-purpose computers or processor cores. In certain embodiments, the special-purpose hardware device may be a graphics processing unit (GPU). In other embodiments, other special-purpose hardware devices may be used as co-processors, such as a Digital Signal Processor (DSP), a Tensor Processing Unit (TPU), a Field-Programmable Gate Array (FPGA), or an Application-Specific Integrated Circuit (ASIC).

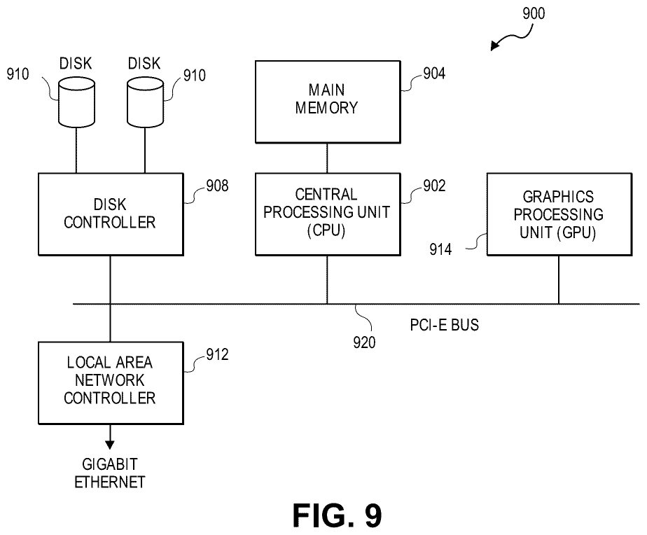

FIG. 9 is a block diagram of an example of a computing hardware device 900 that may be used to perform the calculations described in this disclosure. Computing hardware device 900 comprises a central processing unit (CPU) 902, with attached main memory 904. The CPU 902 may comprise, for example, eight processing cores, thereby enhancing performance of any parts of the computer software that are multi-threaded. The size of main memory 904 may be, for example, 64 G-Bytes. The CPU 902 is connected to a Peripheral Component Interconnect Express (PCIe) bus 920. A graphics processing unit (GPU) 914 may also be connected to the PCIe bus 920. In computing hardware device 900, the GPU 914 may or may not be connected to a graphics output device such as a video monitor. If not connected to a graphics output device, GPU 914 may be used purely as a high-speed parallel computation engine. The computing software may obtain significantly higher performance by using GPU 914 for a portion of the calculations, compared to using CPU 902 for all the calculations. The CPU 902 communicates with the GPU 914 via PCIe bus 920. In other embodiments (not illustrated) GPU 914 may be integrated with CPU 902, rather than being connected to PCIe bus 920. Disk controller 908 may also be attached to the PCIe bus 920, with, for example, two disks 910 connected to disk controller 908. Finally, a local area network (LAN) controller 912 may also be attached to the PCIe bus, and provide Gigabit Ethernet (GbE) connectivity to other computers. In some embodiments, the computer software and/or the design data are stored on disks 910. In other embodiments, either the computer programs or the design data or both the computer programs and the design data may be accessed from other computers or file serving hardware via the GbE Ethernet or other connectivity solutions such as Infiniband.

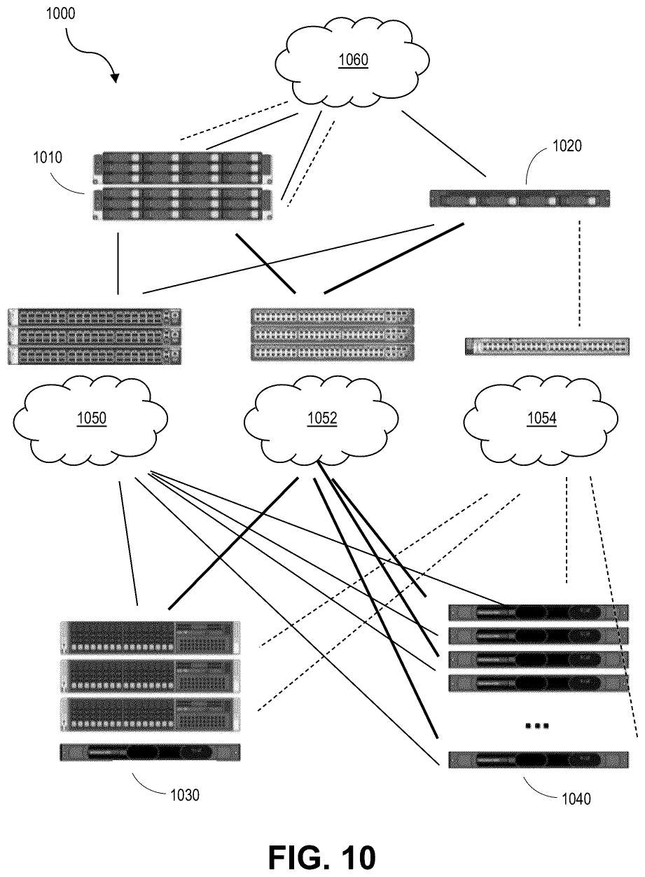

FIG. 10 is another embodiment of a system for performing the computations of the present embodiments. The system 1000 may also be referred to as a Computational Design Platform (CDP), and includes a master node 1010, an optional viewing node 1020, an optional network file system 1030, and a GPU-enabled node 1040. Viewing node 1020 may not exist or instead have only one node, or may have other numbers of nodes. GPU-enabled node 1040 can include one or more GPU-enabled nodes. Each GPU-enabled node 1040 may be, for example, a GPU, a CPU, a paired GPU and CPU, multiple GPUs for a CPU, or other combinations of GPUs and CPUs. The GPU and/or CPU may be on a single chip, such as a GPU chip having a CPU that is accelerated by the GPU on that chip, or a CPU chip having a GPU that accelerates the CPU. A GPU may be substituted by other co-processors.

The master node 1010 and viewing node 1020 may be connected to network file system 1030 and GPU-enabled nodes 1040 via switches and high-speed networks such as networks 1050, 1052 and 1054. In an example embodiment, networks 1050 can be a 56 Gbps network, 1052 can be a 1 Gbps network and 1054 can be a management network. In various embodiments, fewer or greater numbers of these networks may be present, and there may be various combinations of types of networks such as high and low speeds. The master node 1010 controls the CDP 1000. Outside systems can connect to the master node 1010 from an external network 1060. In some embodiments, a job is launched from an outside system. The data for the job is loaded onto the network file system 1030 prior to launching the job, and a program is used to dispatch and monitor tasks on the GPU-enabled nodes 1040. The progress of the job may be seen via a graphical interface, such as the viewing node 1020, or by a user on the master node 1010. The task is executed on the CPU using a script which runs the appropriate executables on the CPU. The executables connect to the GPUs, run various compute tasks, and then disconnect from the GPU. The master node 1010 can also be used to disable any failing GPU-enabled nodes 1040 and then operate as though that node did not exist.

In some embodiments, a system for reticle enhancement technology includes a computer processor configured to receive a target wafer pattern to be used in reticle enhancement technology; and calculate a function sample array (FSA) for the target wafer pattern, the FSA for the target wafer pattern being a smooth function. The computer processor is also configured to calculate a continuous tone mask (CTM), where the CTM is represented as a smooth function captured as a function sample array (FSA); and to compare the target wafer pattern to a predicted wafer pattern produced by the CTM. In further embodiments, the target wafer pattern is divided into a plurality of tiles, and the computer processor is further configured to compute a cost and derivative data for each tile in the plurality of tiles, the computing of the plurality of tiles being performed in a distributed process. The cost and the derivative data are based on comparing the target wafer pattern and the predicted wafer pattern produced by the CTM.

In some embodiments, a system for reticle enhancement technology comprises one or more computer processing devices configured to perform the steps described herein. For example, the system may include a) a device configured to input a target wafer pattern, the target wafer pattern spanning an entire design area; b) a device configured to divide the entire design area into a plurality of tiles, each tile having a halo region surrounding the tile; and c) a device configured to calculate an optimized mask, wherein the optimized mask is generated by a first trained neural network using the target wafer pattern, wherein the calculating is performed for each tile in the plurality of tiles including its halo region. The devices of a), b) and c) may be one single device (e.g., one computer processor) or more than one device (e.g., more than one computer processor, or a computer cluster, where each computer processor performs one or more of a), b) and c)).

In some embodiments, a system for reticle enhancement technology comprises a computer cluster configured to a) receive a target wafer pattern, the target wafer pattern spanning an entire design area; and b) calculate an optimized mask, wherein the optimized mask is generated by a trained neural network using the target wafer pattern.

In general embodiments, the system is a computer processor, which in some embodiments can include graphical processing units or other co-processors for performing distributed computation, such as parallel processing. In some embodiments, the graphical processing units or other co-processors may be configured to interconnect with each other for fast communication. The computer processor is configured to receive a target pattern to be used in reticle enhancement technology, and generate a target pattern function for the target pattern, where the target pattern function is a FSA. The computer processor is also configured to generate a CTM and compare the target pattern function to a predicted pattern function produced by the CTM. The CTM is a smooth function. The computer processor is also configured to generate an optimized QTM using a neural network, wherein the QTM is converted from the CTM before optimization.

Reference has been made in detail to embodiments of the disclosed invention, one or more examples of which have been illustrated in the accompanying figures. Each example has been provided by way of explanation of the present technology, not as a limitation of the present technology. In fact, while the specification has been described in detail with respect to specific embodiments of the invention, it will be appreciated that those skilled in the art, upon attaining an understanding of the foregoing, may readily conceive of alterations to, variations of, and equivalents to these embodiments. For instance, features illustrated or described as part of one embodiment may be used with another embodiment to yield a still further embodiment. Thus, it is intended that the present subject matter covers all such modifications and variations within the scope of the appended claims and their equivalents. These and other modifications and variations to the present invention may be practiced by those of ordinary skill in the art, without departing from the scope of the present invention, which is more particularly set forth in the appended claims. Furthermore, those of ordinary skill in the art will appreciate that the foregoing description is by way of example only, and is not intended to limit the invention.

What is claimed:

1. A method for reticle enhancement technology (RET) comprising:
a) inputting a target wafer pattern, the target wafer pattern spanning an entire design area;
b) dividing the entire design area into a plurality of tiles, each tile having a halo region surrounding the tile; and
c) calculating an optimized mask, wherein the optimized mask is generated by a first trained neural network using the target wafer pattern,
wherein the calculating is performed for each tile in the plurality of tiles including its halo region.

2. The method of claim 1, wherein the first trained neural network uses image loss.

3. The method of claim 2, wherein the image loss comprises L1 and L2 losses.

4. The method of claim 2, wherein the image loss comprises a hinge loss.

5. The method of claim 1, wherein the optimized mask is a quantized tone mask (QTM).

6. The method of claim 5, wherein the QTM comprises sub-resolution assist features (SRAFs).

7. The method of claim 5, further comprising retraining the first trained neural network to create a second trained neural network, wherein the second trained neural network generates a refined QTM from the QTM.

8. The method of claim 7, wherein the second trained neural network further comprises a loss function to generate the refined QTM.

9. The method of claim 7, wherein the retraining further comprises calculating a predicted wafer pattern using the refined QTM.

10. The method of claim 1, further comprising generating a final mask using a cost function, wherein the generating is performed as a post-process.

11. The method of claim 10, wherein the cost function further comprises a mask rule check (MRC).

12. The method of claim 10, wherein the cost function further comprises an MRC gradient.

13. The method of claim 10, wherein the generating comprises a third trained neural network.

14. The method of claim 1, wherein the first trained neural network comprises a U-net.

15. The method of claim 1, wherein each tile is further divided into subtiles of 512×512 pixels.

16. The method of claim 15, wherein the each subtile has a halo with a width of 256 pixels.

17. A system for reticle enhancement technology (RET), comprising:
a computer cluster configured to:
a) receive a target wafer pattern, the target wafer pattern spanning an entire design area; and
b) calculate an optimized mask, wherein the optimized mask is generated by a trained neural network using the target wafer pattern.

18. The system of claim 17, wherein:
the target wafer pattern is divided into a plurality of tiles, each tile having a halo region surrounding the tile, wherein the calculation of the optimized mask is performed for each tile in the plurality of tiles including the halo region.

19. The system of claim 18, wherein a single tile in the plurality of tiles, including the halo region, is further divided into subtiles.
